(19) United States
(12) Patent Application Publication
(10) Pub. No.: US 2023/0093407 A1
(43) Pub. Date: Mar. 23, 2023

(54) APPARATUS AND METHOD WITH NEURAL NETWORK OPTIMIZATION

(71) Applicant: Samsung Electronics Co., Ltd., Suwon-si (KR)

(72) Inventors: Fangfang DU, Xi'an (CN); Fang LIU, Xi'an (CN); Liang LI, Xi'an (CN); Pengfei ZHAO, Xi'an (CN); Fengtao XIE, Xi'an (CN)

(73) Assignee: Samsung Electronics Co., Ltd., Suwon-si (KR)

(21) Appl. No.: 17/946,218

(22) Filed: Sep. 16, 2022

(30) Foreign Application Priority Data
Sep. 18, 2021 (CN) 202111098870.3
Jun. 15, 2022 (KR) 10-2022-007820

(51) Int. Cl. G06N 3/063; G06N 3/08

(52) U.S. Cl. CPC G06N 3/063; G06N 3/08

(57) ABSTRACT

A method and apparatus with neural network optimization are provided. A method is performed by a device storing a target network block and processing hardware that performs optimizing for the target network block, the method includes generating, by the processing hardware, an extended network block of the target network block by increasing, a number of channels of a target operation branch in the target network block to a determined number of channels, wherein the target network block includes operation branches that include the target operation branch, and wherein each operation branch includes at least one respective channel, determining importance measures of the respective operation branches, including the target operation branch with the increased number of channels, in the extended network block, and clipping a channel of the target operation branch in the extended network block, the clipping is performed according to the importance measures of the respective operation branches.

### CROSS-REFERENCE TO RELATED APPLICATIONS

This application claims the benefit under 35 USC § 119(a) of Chinese Patent Application No. 202111098870.3 filed on Sep. 18, 2021, in the China National Intellectual Property Administration, and Korean Patent Application No. 10-2022-0072820, filed on Jun. 15, 2022, in the Korean Intellectual Property Office, the entire disclosures of which are incorporated herein by reference for all purposes.

### BACKGROUND

### 1. Field

The following description relates to deep learning technology, and more particularly, to optimizing a neural network.

### 2. Description of Related Art

Neural network optimization methods use a variety of approaches. One approach involves a network designer manually adjusting the distribution of channels in a neural network (“network” hereafter) to correspond to a type of operation to be performed by the network. The need for a professional designer is inconvenient and the task of manually optimizing and adjusting the network is time consuming. Another approach is to introduce a skip connection into a network, which may replace some original operations and may improve network accuracy. Yet another approach is to adjust some channels and replace other channels through linear transformation or some simple operations. Another approach has been to clip network branches or channels to reduce network size (i.e., pruning).

Some such prior approaches may degrade network performance due to improper operation replacement, improper operation clipping/pruning, improper operation transformation, or improper channel clipping/pruning. Some essential operations might be replaced, or some important channels might be clipped.

The above description has been possessed or acquired by the inventor(s) in the course of conceiving the present disclosure and was not necessarily publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method is performed by a computing device including storage hardware storing a target network block and processing hardware that performs optimizing for the target network block, the method includes generating, by the processing hardware, an extended network block of the target network block by increasing, in the storage hardware, a number of channels of a target operation branch in the target network block to a determined number of channels, wherein the target network block includes operation branches that include the target operation branch, and wherein each operation branch includes at least one respective channel, determining, by the processing hardware, importance measures of the respective operation branches, including the target operation branch with the increased number of channels, in the extended network block, and clipping, by the processing hardware, a channel of the target operation branch in the extended network block, wherein the clipping is performed according to the importance measures of the respective operation branches including the target operation branch.

The method may further include generating an output of the target network block by splicing outputs of all the channels of the operation branches included in the target network block.

The determined number of channels may be determined to be equal to a total number of channels in the target network block.

The generating of the extended network block may include increasing the number of channels of each of the respective operation branches in the target network block to the determined number of channels.

The channel may be clipped such that a total number of channels remaining in the clipped extended network block is less than or equal to a total number of channels in the target network block.

The importance measure of each respective operation branch in the extended network block may be based on an importance value of each respective channel thereof, and the clipping of the channel of the operation branch may include selecting the target channel for clipping based on the target channel having an importance value that may be not greater than an importance threshold.

The clipping of the channel may be performed such that, when a total number of remaining channels in the clipped extended network block may be less than a total number of channels in the target network block, the importance threshold satisfies a requirement of a ratio of a number of channels of each operation branch in the clipped extended network block to a number of channels of a corresponding operation branch in the target network block to be equal to or greater than 0.2 and less than or equal to 1, and the ratio corresponding to each operation branch satisfies a requirement that all the ratios may be not 1.

The determining of the importance value of each operation branch in the extended network block may include determining a weight of each operation branch and a weight of each channel of each operation branch in the extended network block through a first equation, and determining an importance of each operation branch in the extended network block, based on the weight of each operation branch and the weight of each channel of each operation branch, and wherein the extended network block may include m+1 operation branches and n+1 outputs, wherein the first equation may include Fⱼ=Σᵢ₌₀^{m}Yᵢ×Wᵢⱼ×Fᵢⱼ, wherein Fⱼ may be an output of sequence number j 0=0, 1, 2, . . . , n), Yᵢ may be a weight of an operation branch of sequence number i (i=0, 1, 2, . . . , m), Wᵢⱼ may be a weight of a channel of sequence number ij, Fᵢⱼ may be an output of a channel of sequence number ij, and the channel of sequence number ij may be a channel of sequence number j in the operation branch of sequence number i.

The determining of the importance value of each operation branch in the extended network block, based on the weight of each operation branch and the weight of each channel of each operation branch may include when Yᵢ×Wᵢⱼ, which may be a weight product of a channel of sequence number ij, satisfies a second equation may further include Yᵢ×Wᵢⱼ=max{Y₀×W₀ⱼ, Y₁×W₁ⱼ, . . . , Yₘ×Wₘⱼ}, storing or marking, in the storage hardware, the channel of sequence number ij as a maximum-contribution channel, counting the number of maximum-contribution channels in each operation branch as a contribution number, and determining an importance of each operation branch according to the contribution number of each operation branch.

The determining of the importance value of each operation branch in the extended network block may include determining an importance measure of each respective operation branch based on a relationship between a weight product of each channel of each operation branch and a weight product threshold.

The method may further include selecting the target network block from a neural network stored in the storage hardware, wherein the target network block ma include a sub-network of the neural network.

The generating of the target network block may include selecting a network block from a neural network of which the network block may be a sub-network thereof, and generating the target network block by adding an operation branch to the selected network block.

The target network block may include one network block that may be a sub-network of a neural network, and wherein the method further may include determining an importance measure of each respective operation branch in the network block, generating a transition network block by clipping at least one operation branch in the network block according to the importance measure of each operation branch, and generating the target network block by increasing a number of channels of at least one operation branch in the transition network block, wherein a total number of channels of the target network block may be less than a total number of channels in the network block.

In one general aspect, an apparatus includes processing hardware, and storage hardware storing a target network block and storing instructions configured to, when executed by the processing hardware, configure the processing hardware to generate an extended network block by increasing a number of channels in a target operation branch in the target network block to a preset number of channels, wherein the target network block may include operation branches that include the target operation branch, and wherein each operation branch may include at least one respective channel, determine an importance measure of each respective operation branch in the extended network block, and clip a channel of the target operation branch in the extended network block according to the importance measures of the respective operation branches including the target operation branch.

The channel may be clipped such that a total number of remaining channels in the clipped extended network block is less than or equal to a number of channels in the target network block.

The importance measure of each operation branch in the extended network block may be based on an importance measure of each respective channel thereof, and a channel may be selected for clipping based having an importance value that may be less than an importance threshold.

The clipping may be performed such that when a total number of remaining channels in the clipped extended network block may be less than a total number of channels in the target network block, the importance threshold satisfies a requirement of a ratio of a number of channels of each operation branch in the clipped extended network block to a number of channels of a corresponding operation branch in the target network block to be equal to or greater than 0.2 and equal to or less than 1, and the ratio corresponding to each respective operation branch satisfies a requirement that all the ratios may be not 1.

A weight of each operation branch and a weight of each channel of each operation branch in the extended network block may be determined through a first equation, and an importance of each operation branch in the extended network block may be determined based on the weight of each operation branch and the weight of each channel of each operation branch, wherein the extended network block may include m+1 operation branches and n+1 outputs, wherein the first equation may include Fⱼ=Σᵢ₌₀^{m}Yᵢ×Wᵢⱼ×Fᵢⱼ, and wherein Fⱼ denotes an output of sequence number j (j=0, 1, 2, . . . , n), Yᵢ may be a weight of an operation branch of sequence number i (i=0, 1, 2, . . . , m), Wᵢⱼ may be a weight of a channel of sequence number ij, Fᵢⱼ may be an output of a channel of sequence number ij, and the channel of sequence number ij may be a channel of sequence number j in the operation branch of sequence number i.

The importance value of each respective operation branch in the extended network block may be determined based on the weight of each respective operation branch and the weight of each respective channel of each respective operation branch, wherein when Yᵢ×Wᵢⱼ, which is a weight product of a channel of sequence number ij, satisfies a second equation comprising Yᵢ×Wᵢⱼ=max{Y₀×W₀ⱼ, Y₁×W₁ⱼ, . . . , Yₘ×Wₘⱼ}, wherein the channel of sequence number ij is marked or stored in the storage hardware as a maximum-contribution channel, and wherein a count of the number of maximum-contribution channels in each operation branch may be stored as a contribution number, and an importance of each operation branch may be determined according to the respectively corresponding contribution number.

The importance value of each respective operation branch in the extended network block may be determined based on the weight of each operation branch and the weight of each channel of each operation branch, an importance value of each operation branch may be determined according to a relationship between a weight product of each channel of each operation branch and a weight product threshold.

In one general aspect, a method is performed by a computing device including processing hardware and storage hardware, the method includes optimizing, by the processing hardware, a neural network stored in the storage hardware, the optimizing including selecting a network block from the neural network, the network block including branches, each branch including a respective original number of original channels, wherein each original channel includes a respective channel weight, and the branches include a target branch, determining a number of extension channels to add to the network block based at least on the number of channels of a target branch, and adding the determined number of extension channels to the network block such that the network block includes the original channels and the extension channels, and pruning a target channel from the network block, the target channel including one of the extension channels or one of the original channels.

At least one branch in the finalized network block may include a plurality of the original channels and a plurality of the extension channels, and a total number of channels in the finalized network block may include a total number of the original channels before the adding of the extension channels.

The method may include generating importance measures for the respective branches and selecting a branch for pruning, or for pruning a channel thereof, based on the importance measures.

The importance measure of a corresponding branch may be generated based on the channel weights thereof.

The target channel may be selected from among the extension and original channels of the target branch based on the selection of the target branch.

Other features and aspects will be apparent from the following detailed description, the drawings, and the claims.

### BRIEF DESCRIPTION OF THE DRAWINGS

FIG. 1 illustrates an example of a network optimization method implemented by a computer, according to one or more embodiments.

FIG. 2 illustrates an example of a target network block, according to one or more embodiments.

FIG. 3 illustrates another example of a target network block, according to one or more embodiments.

FIG. 4A illustrates another example of a target network block, according to one or more embodiments.

FIG. 4B illustrates the target network block of FIG. 4A after extension thereof, according to one or more embodiments.

FIG. 5A illustrates another example of a target network block, according to one or more embodiments.

FIG. 5B illustrates an optimized version of the target network block of FIG. 5A, according to one or more embodiments.

FIG. 6A illustrates another example of a target network block, according to one or more embodiments.

FIG. 6B illustrates an optimized version of the target network block of FIG. 6A, according to one or more embodiments.

FIG. 7 illustrates another example network optimization method, according to one or more embodiments.

FIG. 8A illustrates an example of a selected network block, according to one or more embodiments.

FIG. 8B illustrates an example of a target network block corresponding to the selected network block of FIG. 8A, according to one or more embodiments.

FIG. 8C illustrates an optimized version of the target network block of FIG. 8B, according to one or more embodiments.

FIG. 9A illustrates another example of a selected network block, according to one or more embodiments.

FIG. 9B illustrates an example of a transition network block corresponding to the selected network block of FIG. 9A, according to one or more embodiments.

FIG. 9C illustrates an example of a target network block corresponding to the transition network block of FIG. 9B, according to one or more embodiments.

FIG. 9D illustrates an example of the optimized target network block of FIG. 9C, according to one or more embodiments.

FIG. 10 illustrates an example of an apparatus for optimizing a network, according to one or more embodiments.

FIGS. 11A-11B illustrate examples a network optimization/training apparatus, according to one or more embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

A method of optimizing a network structure in one or more embodiments is to first increase the number of channels of each respective operation branch in a target network block, and then decrease the number of channels of each operation branch in the target network block. That is, for a given/target network block (e.g., a subnet or layer of the relevant network) channel extension is performed first, and then channel clipping is performed. Compared with simple clipping, the method may increase the number of channels for operation branches having high importance but insufficient numbers of channels prior to extension, thereby improving network performance. In addition, the method may reduce the number of channels for operation branches having low importance. Such a method reasonably allocates channels between operation branches and may enable a thus-optimized target network block to have high precision and low latency.

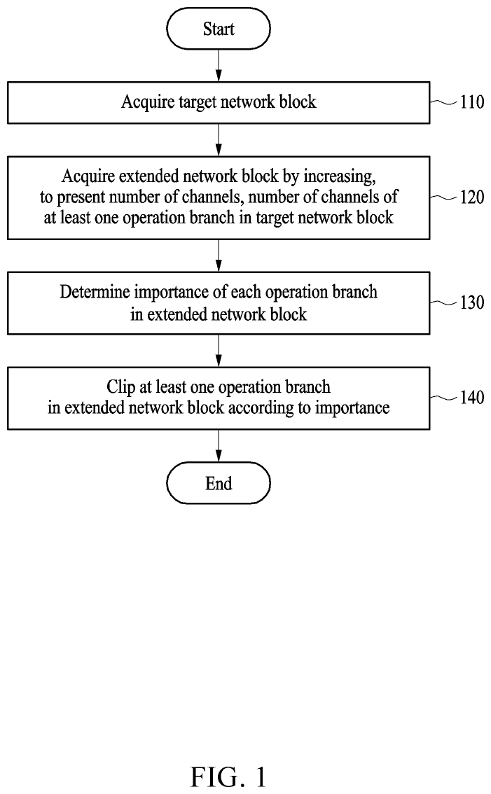

FIG. 1 illustrates a network optimization method implemented by a computer, according to one or more embodiments.

Referring to FIG. 1, a target network block is obtained in operation 110. The target network block includes at least two operation branches. Each operation branch of the target network block includes at least one channel. And, an output of the target network block is obtained by splicing (e.g., aggregating or pooling) outputs of all channels of the target network block.

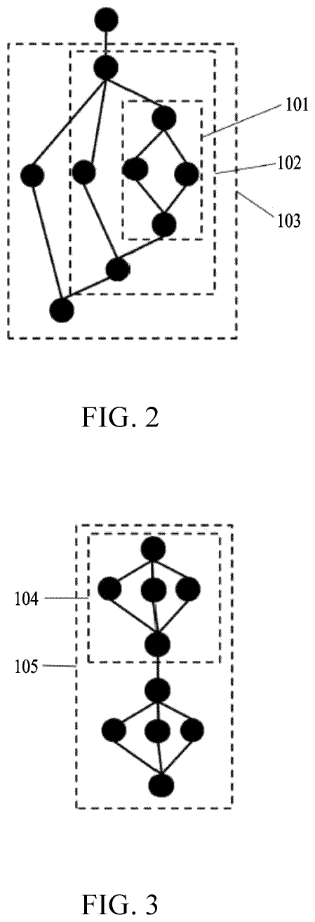

FIGS. 2 and 3 illustrate examples of a target network block according to one or more embodiments.

FIG. 2 illustrates a first example of a target network block. FIG. 3 illustrates a second example of a target network block.

According to some embodiments, network optimization methods may optimize a neural network structure. Specifically, a network block in a neural network targeted for optimization will be referred to as a target network block. For example, a part of the entire neural network (i.e., a sub-network) may be selected as the target network block, and optimization thereof may improve the entire neural network. There may be flexibility in how a target network block is selected for optimization.

As noted, a target network block may include at least two operation branches, and a single operation branch thereof may correspond to one network operation (an operation performed by the network when performing an inference). For example, a target network block 101 and a network block 104 are shown in FIG. 3. A network operation of either target network block may be a simple network operation, such as a 1×1 convolution operation, or may be a complex network operation, such as an inception operation, for example.

A single operation branch may be a complex computing operation. That is, an operation branch may itself correspond to a network block, and the target network block may include another network block as a part of the structure thereof. For example, see the target network block 102 illustrated in FIG. 2. A target network block may be a multi-layered and/or nested network block, such as the network block 103 shown in FIG. 2.

In one embodiment, a network block having the simplest structure may be optimized first and then a subsequent (e.g., encompassing) layer may be optimized. For example, referring to FIG. 2, the network block 101 may be optimized first, and an output of the optimized network block 101 may then be used as an output of an operation branch of the network block 102. Similarly, after network block 101 is optimized, the network block 102 may be optimized. Finally, the network block 103 may be optimized by taking an output of the optimized network block 102 as an output of an operation branch of the network block 103.

A target network block may include two or more network blocks connected in series. For example, network block 105 in FIG. 3 has network block 104 as an upstream network block. Network block 104 may be optimized first and then an output of the optimized network block 104 is taken as an input of a downstream network block when optimizing the network block 105. An entire network block may be directly optimized with techniques described herein regardless of a type of structure of the target network block.

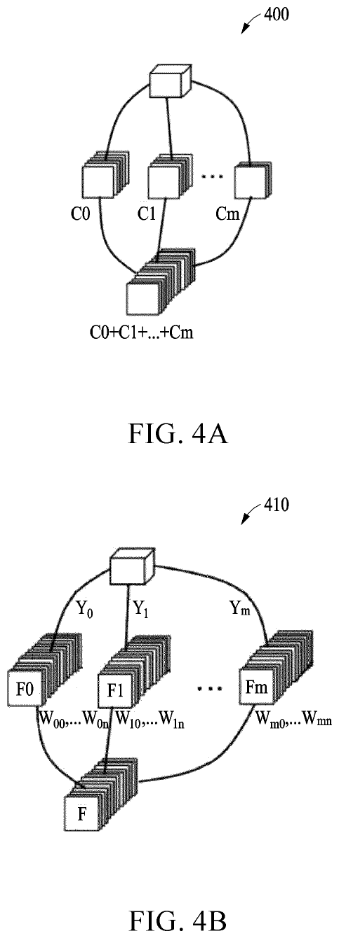

An output of a target network block produced by splicing (e.g., aggregating or pooling) outputs of all channels, as described with reference to FIGS. 4A and 4B.

FIG. 4A illustrates a third example of a target network block 400 according to one or more embodiments. FIG. 4B illustrates a version of the target network block after applying extension processing thereto.

As shown in FIG. 4A, the target network block may include m+1 operation branches (indexed from 0 to m as shown in FIG. 4A). The first operation branch includes C0 channels, the second operation branch includes C1 channels, and so forth, with the m+1-th operation branch including Cm channels. Each channel may have one output after calculation. Thus, the first operation branch may calculate C0 outputs (for its C0 channels), the second operation branch may calculate C1 outputs, and the m+1-th operation branch may calculate Cm outputs (one for each of its Cm channels). Splicing these outputs may result in C0+C1+ . . . +Cm outputs as an output of the target network block in FIG. 4A.

Referring to FIG. 1, in operation 120, the number of channels of at least one operation branch in the target network block is increased to a preset number to generate an extended network block (an extended version of the target network block). Techniques to determine the preset number are described below. “Preset” means that the number is determined before it is used.

Referring to FIG. 4A, the numbers of channels included in different respective operation branches in the target network block may vary. The importance of each operation branch within an entire neural network will usually differ from branch to branch. In order to maintain (or increase) the influence (e.g., on inferencing or on an output) of any given pre-optimization operation branch that has high importance at a high level, and to prevent clipping (or excessive clipping) of any given pre-optimization operation branch (or channels thereof) that has high importance and yet an insufficient number of channels, some embodiments may first calculate importance measures of respective operation branches in a target network, and according to the importance measures, select and extend the operation branch(es) for which it would be beneficial to increase the respective numbers of channels thereof, and yet at the same time provide/maintain an operation space for clipping subsequent channels to help channel allocation in the target network block (e.g., not over-consuming working memory needed for optimizing and/or facilitating splicing).

In some embodiments, only one or some operation branches in a target network block may be extended. For example, to reduce the total number of channels and the amount of calculations of each operation branch, only operation branch(es) having sufficiently high importance measure(s) (e.g., above a threshold or similar condition) may be extended. In general, the amount of calculations for an extended network block is proportional to the total of the number of channels included, by extension, in the network block (i.e., the number of original and extension channels). Accordingly, extending only some operation branches of a target network block may reduce the amount of calculations, such as the amount of calculations that subsequently determine importance, during an optimization process. In some embodiments, all operation branches may be extended to reduce the cost of predicting importance measures of each respective operation branch and to improve optimization, which may involve aspects of the network other than accuracy, for example inference speed, reduced over-fitting, or the like. For any given implementation, an appropriate extension strategy may be selected according to the need of the specific scenario, and the present disclosure is not particularly limited thereto.

In some embodiments, the number of channels to be extended for an operation branch in a target network block may be equal to (or otherwise based on, e.g., a portion of) a total number of channels in the original/unextended target network block. The number of channels in the unextended target network block is set to be the sum of the numbers of original channels included in the respective operation branches of the target network block. Referring to FIG. 4A, wherein Ci is the number of channels of the i-th channel, the total number of channels in the target network block is initially the sum C0+C1+ . . . +Cm. For optimizing network performance, more channels are allocated to more important operation branches of the target network block and, in an extreme case, for example, all channels that are to be allocated are allocated to the single most important operation branch. As mentioned above, optimization methods of the present disclosure extend channels of an operation branch and then clip channels. To avoid a situation in which a corresponding operation branch is sufficiently (or optimally) extended and there are not enough channels for clipping, the number channels to be extended may be set to be equal to a total number of channels included in the target network block prior to optimization thereof, which may ensure a sufficient space for subsequent clipping (“prior to” does not exclude earlier optimization of a network block that is upstream from, or a sub-block of, the target network block). Extending channels of an operation branch first (before optimization) may help to ensure performance of the corresponding finally optimized network by sufficiently increasing the number of channels of a corresponding operation branch, which is finally optimized, as necessary (e.g., as features, e.g., weights or statistics thereof, of the network indicate to be beneficial).

In some embodiments, to begin optimizing a target network block, increasing, to the set number of channels, the number of channels of at least one operation branch in the target network block may be performed as follows. The numbers of channels of all respective operation branches in the target network block are respectively increased to each be equal to the total number of channels included in the target network block. If the total number of channels in the target network block 400 shown in FIG. 4A is initially n+1, where n+1=C0+C1+ . . . +Cm, then as shown in FIG. 4B, the number of channels of each of the m+1 operation branches is extended (as individually necessary, and by adding channels thereto) so that each operation branch has n+1 channels, as shown by the extended target network block 410. Such a processing method may sufficiently extend each operation branch in the same way, thus increasing an optimization automation level. Accordingly, the processing method may help assure network performance of an optimized network structure by sufficiently increasing the number of channels in each operation branch.

Referring to FIG. 1, in operation 130, the importance measures of each respective operation branch in an extended network block (e.g., with extended channels) are determined. Regardless of how many channels the extended operation branches may have (including original channels and possibly extension channels), the importance measures of all respective operation branches may be calculated to optimize a channel structure of the entire target network block. In some embodiments, heuristics may be used to avoid computing importance measures of some operation branches, or to assign default importance measures. For example, branches with sufficiently sparse weights and/or channels may be given a 0 importance measure.

In some embodiments, operation 130 may be performed as follows. The following Equation 1 is implemented, by operations of a computing device, to determine a weight of each respective operation branch in an extended network block and a weight of each respective channel of each operation branch. In this case, the extended network block 410 includes m+1 operation branches and n+1 outputs (the number of channels of each extended operation branch).

Fⱼ=Σᵢ₌₀^{m}Yᵢ×Wᵢⱼ×Fᵢⱼ(m+1 channels for each of j+1 branches) Equation 1

Here, n+1=max{No, N₁, N₂, . . . , Nₘ} (e.g. C0+C1+ . . . +Cm as described above), where No is the number of channels of the first operation branch in the extended network block, N₁ is the number of channels of the second operation branch in the extended network block, N₂ is the number of channels of the third operation branch in the extended network block, and Nₘ is the number of channels of the m+1-th operation branch in the extended network block. Fⱼ is the j-th output in a sequence of outputs numbered/indexed (j=0, 1, 2, . . . , n), where the output value is the output value of the same corresponding sequence number in the original target network block. Yᵢ is the i-th operation branch weight of branch weights in a sequence numbered (i=0, 1, 2, . . . , m), Wᵢⱼ is a channel weight of the j-th channel of the i-th operation branch, and Fᵢⱼ is the channel output of the j-th channel of the i-th operation branch. In other words, the channel of the sequence number ij is the channel of the channel sequence/index number j in the operation branch of the branch with sequence/index number i.

Since each operation branch in the extended network block and the numbers of channels of the respective operation branches are determinable and/or known, the value Fᵢⱼ is also determined and the values Yᵢ and Wᵢⱼ may be obtained by inputting Fⱼ and Fᵢⱼ into Equation 1. Then, the importance of each operation branch in the extended network block may be determined based on the weight of each operation branch and the weight of each channel of each operation branch. An output of the extended network block may be the sum of weights of channel outputs in each operation branch in two dimensions of each operation branch weight and channel weight. As each operation branch may directly bear on (or contribute to) the output of the extended network block, the importance measure of each operation branch may be stably obtained based on the branch weight and the channel weight. In sum, an output of the target network block may be obtained by a weighted sum method applied to the extended target network block. Even when a total number of channels in the extended network block is greater than a total number of channels in the target network block before extension, the number of outputs of the extended network block may be still equal to the number of outputs of the target network block, that is, N.

In one embodiment, values of operation branch weights and channel weights may be determined based on a neural architecture search (NAS), which may quickly acquire a reasonable weight value by improving calculation efficiency and by reducing calculation load, while at the same time raising the possibility of optimizing a network structure.

In one embodiment, referring to the example of FIGS. 4A and 4B, each operation branch is given a branch weight Yᵢ (i from 0 to m), and the branch weights Y₀, Y₁, . . . , Yₘ are stored in memory after extending the number of channels of m+1 operation branches to n+1. Each channel of each operation branch is given a channel weight W. Taking an operation branch FO as an example, when weights of each channel of branch FO are stored in memory as W₀₀, . . . , W₀ₙ subsequently, the j+1-th output (i.e., the output Fⱼ of the branch with sequence number j) is the sum of weights of the outputs of j+1 channels in all operation branches, that is, Fⱼ=Y₀×W₀ⱼ×F₀ⱼ+Y₁×W₁ⱼ×F₁ⱼ+ . . . +Yₘ×Wₘⱼ×Fₘ. Then, the branch weight Y and the channel weight W may be processed using the NAS method, regarding the corresponding network branch.

In some embodiments, determining the importance measures of each respective operation branch in the extended network block based on weights of each operation branch and weights of each channel of each operation branch may be performed as follows. The weight product of an operation branch corresponding to a weight of each channel is determined, the determined weight product is stored in memory as the weight product for a corresponding channel, and the importance measure of each respective operation branch is determined based on the weight product. Since the relationship between each operation branch in the extended network block and the output of the extended network block is mainly reflected by the weight product, the importance of each operation branch may be determined using the weight product. Two types of calculation methods thereof are described next, although others may be used.

First, when Yᵢ×Wᵢⱼ, (weight product of a channel with sequence number ij) satisfies the following Equation 2, the channel having the sequence number ij is stored (e.g., marked or counted) as a maximum-contribution channel. The number of maximum contribution channels (channels that satisfy Equation 2, e.g.) in each operation branch is statistically counted and that count (i.e., the cardinality of satisfaction of Equation 2) and serves as a contribution number, and the importance measure of each respective operation branch is determined according to the respective contribution number of each operation branch.

Yᵢ×Wᵢⱼ=max{Y₀×W₀ⱼ,Y₁×W₁ⱼ, . . . ,Yₘ×Wₘⱼ} Equation 2

That is, contribution C′, which has an initial value of 0 in each operation branch (prior to counting), is assigned first to each operation branch and then an operation branch with the maximum-contribution to an output Fⱼ of each sequence number is found. That is, the operation branch of the greatest channel of the corresponding weight product Y×W. 1 is added to the contribution number C′ of the corresponding operation branch to accumulate/count the number of contributions in each respectively corresponding operation branch. Such a calculation method may treat the contribution C′ as the importance measure and may finally allocate the corresponding number of channels to an operation branch according to its C′ value. That is, when an operation branch with the maximum contribution corresponding to every output is selected (selecting an operation branch of a channel having greatest weight product) and when a channel is allocated to a corresponding operation branch, the calculation may become simple and a total number of channels in each operation branch may be equal to a total number of channels in the original target network block before the optimization (e.g., n+1). Under the assumption that the total number of channels remains the same when optimization of the target block is complete, a form of channel re-distribution between different operation branches will have been implemented. It may be understood that each operation branch may correspond to a known (or future) type of network operation (e.g., a convolution) in a network block. When the network block is finally configured/optimized, an actual configured parameter for channels of each operation branch is a number of channels that may not require an additional configuration for each channel. Therefore, clipping channels in the extended network block may not necessarily require individually distinguishing/evaluating each channel of each operation branch and instead may determine the number of channels of each operation branch according to importance. That is, there may not be a need to determine which particular channels are to be clipped and which particular channels are to be retained (on a channel-by-channel basis).

A second technique to determine the importance measure of each respective operation branch is to determine the importance measure according to a degree of correlation between the weight product of each channel and a corresponding weight product threshold. Such a calculation method may use the weight product threshold as a criterion for determining the size of weight product, and then determines the importance measure of an operation branch. In particular, the importance measure of each respective operation branch may be obtained by statistically counting all the channels for which the weight product is greater than a weight product threshold in the corresponding operation branch. The weight product corresponding to each respective channel may be the importance of a corresponding channel, and the importance of the channel may be used as a reflection of, or indication of, the importance of the corresponding operation branch. That is, C′, which in this second technique is the number of channels where the weight product of each operation branch is greater than the weight product threshold, is statistically counted, and finally, the corresponding number of channels is allocated to each operation branch according to a C′ value. In this case, C′ may be an importance measure (similar to the first calculation method), or the weight product Y×W may be understood as the importance measure, which is a parameter distinction and does necessarily not affect the calculation. The calculation method may achieve different methods of calculating importance by configuring different weight product thresholds, thus providing flexibility for the optimization method. Specifically, a weight product threshold may be set at an initial value before optimizing the target network block and may be adjusted several times in combination with optimized network performance to improve the optimized network performance. In some embodiments, both importance-determining techniques may be combined, e.g., two importance measures may be determined and combined (e.g., as a weighted average) for each respective operation branch

Referring to FIG. 1, in operation 140, a channel of at least one operation branch in an extended network block is clipped based on a corresponding importance measure.

The network optimization method may store the appropriate numbers of channels for different respective operation branches according to their respective measures of importance. In particular, the network optimization method may introduce a weight of each channel in addition to a weight of each operation branch when calculating the importance of each operation branch, so that the specific contribution of each operation branch to each output may be quantified or reflected. Accordingly, the network optimization methods may implement structural optimization of the target network block, improve a calculation (e.g., inference) accuracy, and reduce the amount of calculations and less significant information. A neural network with optimized structure may then be trained.

There may be cases where the number of channels in a given operation branch is different since the number of channels in the given operation branch, upon completion of optimization, is less than a total number of channels in the target network block and other operation branches respectively correspond to other operation types.

In some embodiments, when an extended network block is clipped, the network optimization methods may maintain a total number of remaining channels in the clipped extended network block to be less than or equal to the total number of original channels in the original target network block.

In some embodiments, where the extended network block is clipped, when the total number of remaining channels in the clipped extended network block is the same as the total number of channels in the target (initial) network block, the allocation of channels between the operation branches may be optimized without changing the final total number of channels. Moreover, the optimizations may generally cause the numbers of channels in some operation branches to increase and the numbers of channels in other operation branches to decrease, thus providing a channel redistribution between different operation branches. This may provide a stable (consistent) output of the target network block (in relation to before and after the optimization) and may reduce the influence on other portions of the overall network during the localized (block-specific) network optimization.

In cases where the extended network block is clipped and the total number of remaining channels in the clipped extended network block is less than the total number of channels in the target network block, this may be conducive to reducing or blocking redundant channels in the target network block and reducing the amount of calculations of the optimized network block. According to the two importance-measure calculation methods described herein (or others), the following two channel clipping methods may be used, individually or in combination.

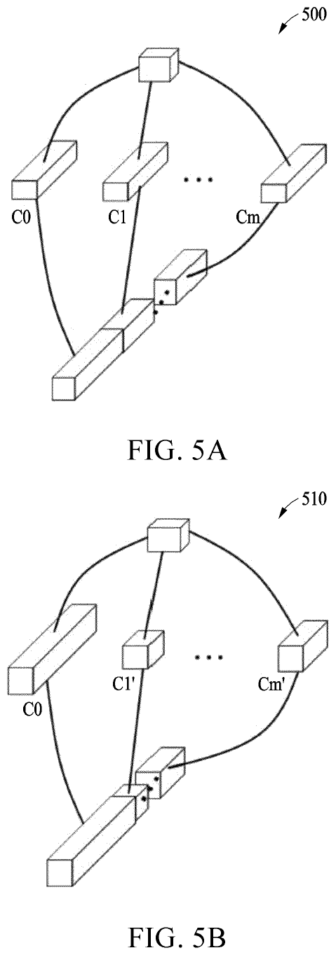

The first channel clipping method assigns the number of corresponding channels to an operation branch according to a contribution number C′. This method may ensure that the total number of channels in the clipped extended network block is equal to the total number of channels in the original target network block. FIGS. 5A and 5B show examples of a target network block before and after optimization when the first method is used.

FIG. 5A illustrates the fourth example of the target network block 500 according to one or more embodiments. FIG. 5B illustrates the optimized target network block 510 of FIG. 5A, according to one or more embodiments.

The second method of channel clipping is to clip channels (in an extended network block) for which the corresponding importance measure is not greater than a importance threshold when the importance is determined by weight product C′, which is the number of channels for which the weight product is greater than a weight product threshold in each operation branch; this number of channels is statistically counted and used as (or a basis to determine) the number of channels to be finally to allocated to the operation branch corresponding to the C′ value.

Another example embodiment is as follows. Each channel of each operation branch in the extension network block is traversed to determine whether importance (e.g., weight product) of a currently traversed channel is not greater than an importance threshold (e.g., a weight product threshold), and the currently evaluated channel is clipped if the importance thereof is not greater than the importance threshold. Such a method may maintain the structure of an original operation branch in the target network block and learns importance (e.g., weight) of each operation branch and a corresponding channel in order to clip some relatively unessential or less impactful (to inference) channels by combining an importance measure of an operation branch with the importance measure of a channel, in order to effectively remove redundant channels, which may improve a calculation (inference) speed of the network. Some embodiments may use the same importance threshold for different operation branches to implement a comprehensive (block-wide or network-wide) comparison and/or may use different importance thresholds for different operation branches. For example, one operation branch might include 4 channels with respective importance values of “0.6”, “0.4”, “0.35”, and “0.2”, respectively. When a target is to clip 50% of channels, an importance threshold may be set to an arbitrary value, such as “0.36”, which is less than “0.4” and greater than or equal to “0.35”. If another operation branch includes 6 channels, the importance of the respective channels might be “0.7”, “0.6”, “0.5”, “0.4”, “0.2” and “0.1”, respectively. When a target is to clip 50% of channels, an importance threshold may be set to an arbitrary value, such as “0.45”, which is less than “0.5” and greater than or equal to “0.4”. In this case, 50% of channels are clipped and respective importance thresholds set for the two operation branches are different.

When the second clipping method is used, channel allocation may be optimized in the same way as the first clipping method. In this case, a weight product threshold may be returned to C0+C1+ . . . +Cm=C0′+C1′+ . . . +Cm′ based on conditions that a total number of channels does not change. In another aspect, each operation branch may be fully retained or clipped to clip redundant channels in the target network block. Optionally, when the redundant channels (for example) in the target network block are clipped (i.e., the total number of remaining channels after clipping the extended network block is kept less than the total number of channels in the target network block) an appropriate importance threshold may be selected and a ratio of (i) the number of channels of each operation branch in the extended network block to (ii) the number of channels of a corresponding operation branch in the target network block may range between “0.2” and “1”. In this case, the ratios corresponding to each work branch are not “1”. That is, the amount of clipping is controlled, thus ensuring that (i) the number of remaining channels of each operation branch in the clipped extended network block is 20% or more of the initial number of channels of the corresponding operation branch in the target network block and that (ii) calculation requirements are satisfied. At the same time, the total/sum number of remaining channels of all of the operation branches (in the clipped extended network block) may not be greater than the initial total/sum number of channels of the corresponding operation branch (of the target network block) to ensure that the number of channels of each operation branch either doesn't change or doesn't decrease. This clipping method may optimize the target network block while satisfying requirements for optimizing the clipped network. In addition, the ratio may be decreased to “0.4” through “1”. In other words, the number of remaining channels should be 40% or more of the initial number of channels to limit the amount of clipping and to meet any calculation requirements/ceilings. In addition, when the number of channels of each operation branch remains unchanged, there is no relative change to the target network block and such a case should be excluded. In other words, it is not the case that all the ratios of each operation branch is “1”.

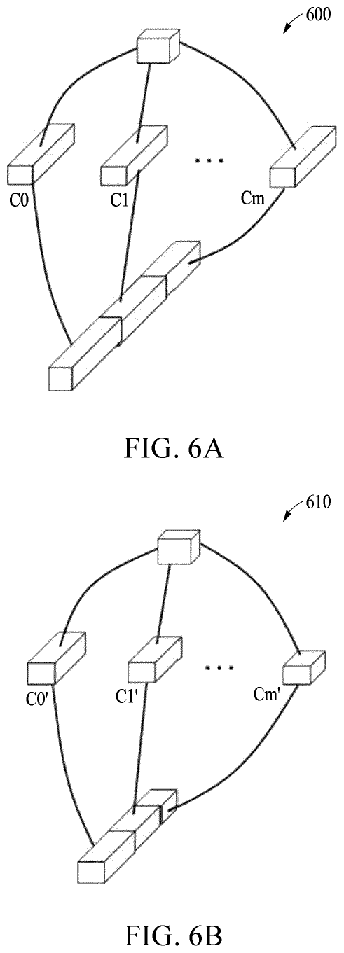

FIGS. 6A and 6B illustrate an example of a target network block before and after optimization when redundant channels of the target network block are clipped, and C0+C1+ . . . +Cm>C0′+C1′+ . . . +Cm′ is satisfied.

FIG. 6A illustrates a fifth example of a target network block 600 according to one or more embodiments. FIG. 6B illustrates an optimized target network block 610 of FIG. 6A according to one or more embodiments.

Since a network block obtained after clipping may restore a splicing (e.g., pooling) output mode of the target network block, the total number of channels in the optimized network block may be reduced, compared to the number of channels in the original target network block, and thus, redundant channels may be clipped.

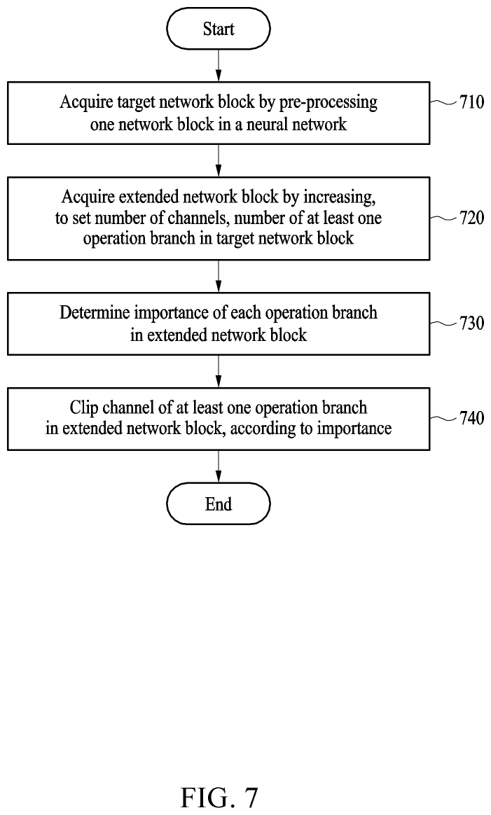

FIG. 7 illustrates a network optimization method implemented by a computer, according to one or more embodiments.

Referring to FIG. 7, the network optimization method acquires a target network block by pre-processing one block of a neural network in operation 710. The target network block may be selected from a larger network using a variety of techniques, e.g., random selection, heuristic selection (e.g., using weights/features of the network), etc. A structure of a network block selected in the neural network is described with reference to operation 110 of FIG. 1. The pre-processing operation may add a new operation branch or clip at least one existing operation branch, for example using known clipping techniques.

In operation 720, the network optimization method forms or generates an extended network block by increasing, to a preset number of channels, the number of channels of at least one target operation branch in the selected target network block.

In operation 730, the network optimization method determines importance measures of each operation branch in the extended network block. For example, operation 730 computes importance measures of the respective operation branches based on parameters in the extended network block (e.g., weights) that are directly or indirectly related to the branches.

In operation 740, the network optimization method clips a channel of at least one operation branch in the extended network block, according to one or more of the importance measures.

In this embodiment, as it relates to the embodiment shown in FIG. 1, some operations of FIG. 7 may refer to corresponding operations in the embodiment shown in FIG. 1, except that in operation 710 the pre-processing is added to the selected network block. The embodiment shown in FIG. 1 may be generally used to implement channel allocation optimization between each operation branch in a situation where an operation branch does not change. However, in some scenarios, such an operation may still not be sufficient to meet an optimization requirement or specification (e.g., an improvement in inference accuracy or speed as measured against test data or computation estimation). In such scenarios, because a new operation branch may be introduced and a scale of a network block structure may be significantly reduced to change an original structure of an operation branch, in advance (during pre-processing), some operation branches of a network block to be optimized are clipped in advance.

When the pre-processing is configured to (or decides to) add a new operation branch, operation 710 may be performed as follows. The network optimization method prepares the target network block by adding at least one operation branch to a network block. The method introduces a new operation branch to a selected network block to form the target network block. For example, the network optimization method may introduce a simple operation branch, such as a 1×1 convolution operation, into the selected network block, so that the calculation of partial output of the network block may be completed through the simple operation branch. Therefore, the network optimization method may be conducive to reducing network parameters and calculations and may also compress the size of the network block. The network optimization method may provide an optimized network block (and by implication, an encompassing network) that selects a complex operation branch, such as an inception unit, to complete the calculation of more complex operation branches so that more detailed features of input data may be extracted and network accuracy may be improved.

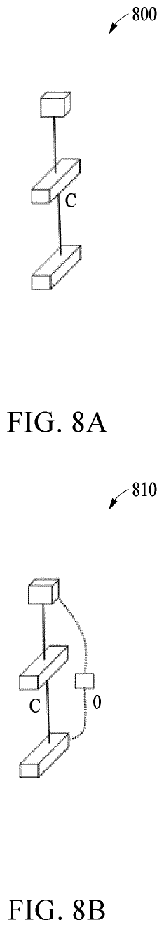

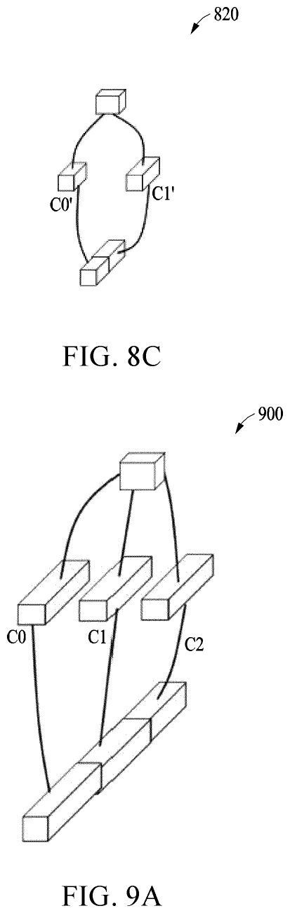

FIGS. 8A and 8C show a network block before and after optimization when a corresponding pre-processing operation is adopted.

FIG. 8A illustrates a first example of a selected network block 800 according to one or more embodiments. FIG. 8B illustrates a target network block 810 corresponding to the selected network block 800 of FIG. 8A according to one or more embodiments. FIG. 8C illustrates the optimized target network block 830 of FIG. 8B according to one or more embodiments.

For example, as shown in FIG. 8A, the selected network block includes one operation branch and the number of channels included therein is C. As shown in FIG. 8B, a network optimization method introduces a new operation branch and forms a target network block (other pre-processing may also be performed, as described above). In this case, the number of channels in the new operation branch is initially 0. The network optimization method performs extension processing on the target network block (including the new branch), and then calculates importance using any of the example methods described herein and adjusts channels of at least two operation branches to acquire an optimized target network block as shown in FIG. 8C. Calculation and adjustment processes may be any of those described herein. In the case where a total number of channels in the target network block does not change, it may be determined that the selected network block satisfies C=C0′+C1′ before and after optimization.

When pre-processing is to clip at least one existing operation branch, operation 710 may be performed as follows. The network optimization method determines the importance measure of each respective operation branch in a network block, clips at least one operation branch from the network block (e.g., according to the importance of each operation branch) to generate/form a transition network block, and generates/forms a target network block based on the transition network block. The network optimization method may determine the importance of each operation branch in the network block to find and directly clip relatively unessential (lower importance) operation branches, with the effect of likely reducing redundant calculations and operation types in the selected network block.

The network optimization may be similar to the operations of calculating importance described herein. First, channels in an operation branch of a network block are extended and then the importance of each operation branch in the extended network block may be calculated using techniques described herein. In other words, the network optimization method may calculate importance measures twice in the entire optimization process. The first calculation of the importance measures is to clip an operation branch, and the second calculation is to re-adjust channels of the remaining operation branches. In the second adjustment, the network optimization method may reallocate channels without changing a total number of channels in the target network block and may clip redundant channels in the target network block. When an operation branch is clipped after extending channels of a selected network block and calculating importance of each operation branch, a total number of channels in a transition network block after clipping is less than a total number of channels in the originally selected network block, since the network optimization method clips an operation branch, which is the operation branch in the originally selected network block before extension. Optionally, generating the target network block based on the transition network block includes acquiring the target network block by increasing the number of channels of the at least one operation branch in the transition network block. In this case, a total number of channels in the target network block is less than a total number of channels in the network block. As stated herein, upon clipping an operation branch, a total number of channels in the transition network block may be significantly reduced, compared to the number of channels in the network block selected in the original neural network. The network optimization method may increase the number of channels in the remaining operation branches to prevent decrease in the accuracy of the network block. At the same time, the network optimization method may limit the total number of channels in the target network block to be less than the total number of channels in the initially selected network block. That is, the total increasing number of channels may be limited to be less than the total number of clipped channels. Therefore, the example network optimization method may decrease the total number of channels, may control increase in the number of channels in the remaining operation branches, and may reduce redundant calculations due to clipped operation branches. In this case, taking the network block as the target network block and adjusting channels may help to improve or guarantee computational performance of an optimized neural network.

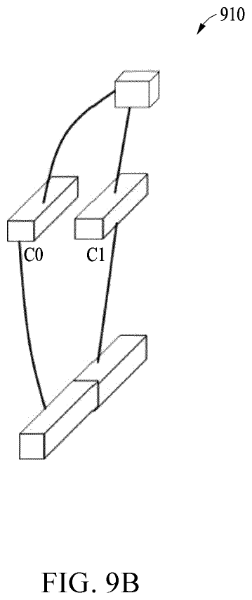

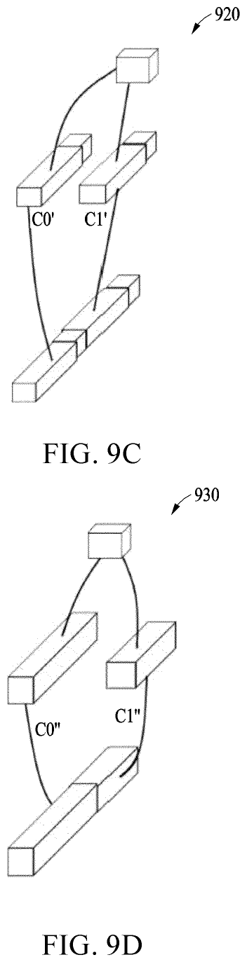

FIGS. 9A through 9D show an example of a network before and after optimization when a pre-processing operation is employed.

FIG. 9A illustrates a second example of a selected network block 900 according to one or more embodiments. FIG. 9B illustrates a transition network block 910 corresponding to the selected network block of FIG. 9A according to one or more embodiments. FIG. 9C illustrates a target network block 920 corresponding to the transition network block of FIG. 9B according to one or more embodiments. FIG. 9D illustrates the optimized target network block 930 of FIG. 9C according to one or more embodiments.

For example, as shown in FIG. 9A, the selected network block includes three operation branches, and the number of channels in each operation branch is C0, C1, and C2, respectively. The network optimization method determines that the third operation branch may be (and is) clipped to thereby generate a transition network block after extension processing and importance calculation, as shown in FIG. 9B. Then, the network optimization method increases the number of channels of the remaining two operation branches to C0′ and C1′, respectively, guarantees C0′+C1′<C0+C1+C2, and acquires a target network block, as shown in FIG. 9C. Then, the network optimization method performs extension processing on the target network block, then calculates the importance values using any of the example methods described herein, and adjusts channels of the two operation branches to form an optimized target network block, as shown in FIG. 9D. Calculation and adjustment techniques may be as described. In the case where a total number of channels in the target network block does not change, it may be determined that the target network block satisfies C0′+C1′=C0″+C1 before and after optimization.

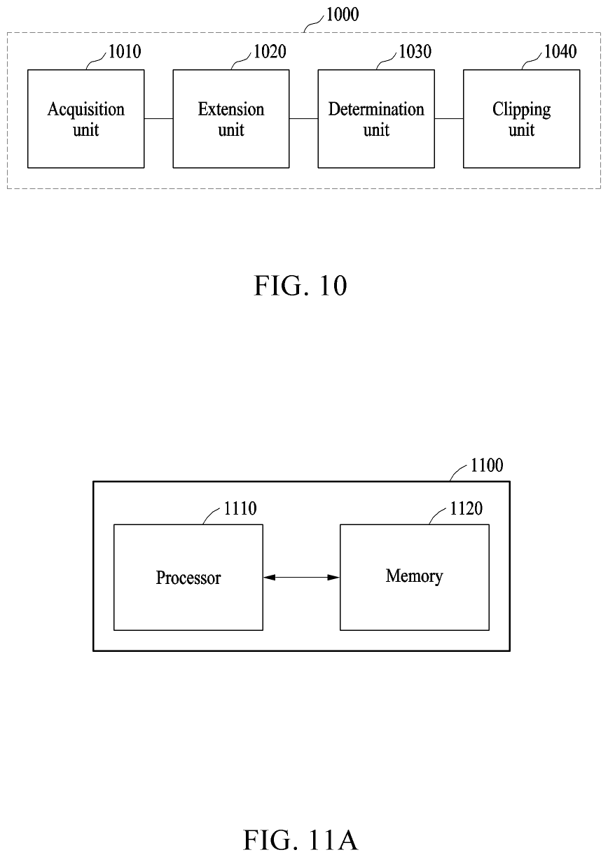

FIG. 10 illustrates an example of an apparatus for optimizing a network, according to one or more embodiments.

Referring to FIG. 10, a network optimization apparatus 1000 includes an acquirer 1010, an extender 1020, a determiner 1030, and a clipper 1040.

The acquirer 1010 may acquire a target network block. In this case, the target network block includes at least two operation branches, each operation branch includes at least one channel, and an output of the target network block is obtained by splicing outputs of all channels.

Optionally, the acquirer 1010 may specifically acquire or select one network block in a neural network and use the acquired network block as a target network block.

Optionally, the acquirer 1010 may also acquire one network block in a neural network and acquire the target network block by adding at least one operation branch to the network block.

Optionally, the acquirer 1010 also acquires or selects one network block in a neural network, determines the importance of each operation branch in the network block, and clips at least one operation branch in the network block, according to the importance of each operation branch, to acquire a transition network block. The acquirer 1010 may increase the number of channels of the at least one operation branch in the transition network block to form a target network block. In this case, a total number of channels in the target network block is less than a total number of channels in the network block.

The extender 1020 may form an extended network block by increasing, to a preset number of channels, the number of channels of at least one operation branch in the target network block.

Optionally, the preset number is equal to the initial total number of channels in the target network block.

Optionally, the extender 1020 may also increase the number of channels in all operation branches included in the target network block to the total number of channels in the target network block.

The determiner 1030 may determine the importance of each operation branch in the extended network block.

Optionally, the determiner 1030 may also determine a weight of each operation branch in the extended network block and a weight of each channel of each operation branch through Equation 1. In this case, the extended network block includes m+1 operation branches and n+1 outputs.

Fⱼ=Σᵢ₌₀^{m}Yᵢ×Wᵢⱼ×Fᵢⱼ Equation 1

Here, Fⱼ is an output of sequence number j (j=0, 1, 2, . . . , n), Yᵢ is a weight of an operation branch of sequence number i (i=0, 1, 2, . . . , m), Wᵢⱼ is a weight of a channel of sequence number ij, Fᵢⱼ is an output of a channel of sequence number ij, and the channel of sequence number ij is a channel of sequence number j in an operation branch of sequence number i.

The determiner 1030 may determine the importance of each operation branch in the extended network block, based on a weight of each operation branch and a weight of each channel of each operation branch.

Optionally, the determiner 1030 determines the importance of each operation branch in the extended network block based on the weight of each operation branch and the weight of each channel of each operation branch, and stores (or marks) in memory a channel of sequence number ij as a maximum contribution channel when Yᵢ×Wᵢⱼ, which is a weight product of the channel with sequence number ij, satisfies the following Equation 2, statistically counts the number of maximum contribution channels of each operation branch as a contribution number, and determines the importance of each operation branch according to the contribution number of each operation branch.

Yᵢ×Wᵢⱼ=max{Y₀×W₀ⱼ,Y₁×W₁ⱼ, . . . ,Yₘ×Wₘⱼ} Equation 2

Optionally, the determiner 1030 may also determine the importance of each operation branch according to a degree of correlation (or a proportion) between the weight product of each channel of each operation branch and a weight product threshold.

The clipper 1040 may clip a channel of at least one operation branch in the extended network block based on importance.

Optionally, the clipper 1040 may clip a channel of at least one operation branch in the extended network block based on importance thereof so that a total number of remaining channels in the clipped extended network block is made to be less than or equal to a total number of channels in the target network block.

Optionally, the importance of each operation branch may include the importance of each channel of each operation branch and the clipper 1040 may clip a channel of which an importance is not greater than an importance threshold in the extended network block.

Optionally, when the total number of remaining channels in the clipped extended network block is less than the total number of channels in the initial target network block, an importance threshold satisfies the following conditions. A ratio of the number of channels of each operation branch in the clipped extended network block to the number of channels of a corresponding operation branch in the target network block is greater than or equal to “0.2” and less than or equal to “1”, and all ratios corresponding to each operation branch are not “1”.

Operations referred to as “optional” does not imply that other operations are required; “optional” is used to emphasize that such operations are optional within a particular context or example. Other operations are understood to be optional in view of their context and/or the overall description herein (including the original claims), although such operations may not be explicitly qualified as such.

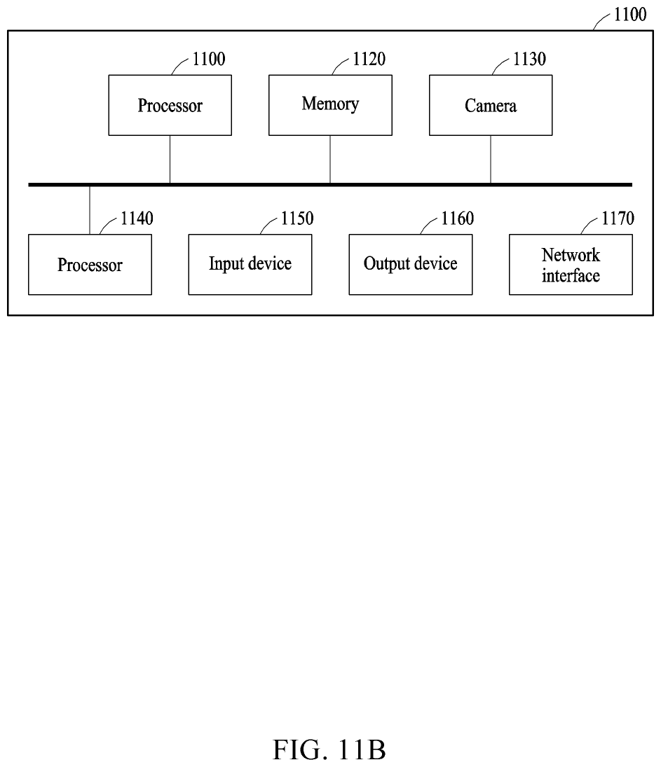

FIGS. 11A and 11B are block diagrams illustrating examples of a network training/optimization apparatus. Referring to FIG. 11A, a training/optimization apparatus 1100 includes a processor 1110 and a memory 1120. Referring to FIG. 11B, the training/optimization apparatus 1100 includes one or more processors 1110, one or more memories 1120, one or more cameras 1130, one or more storage devices 1140, one or more output devices 1160, and one or more network interfaces 1170, as well as an example bus 1080 providing communication and data exchange between the example components.

The processor 1110 is configured to perform one or more, any combination, or all operations described herein. For example, the processor 1110 may be configured to perform one or more, any combination of, or all operations related to the aforementioned network training and/or optimization processes. For example, the processor 1110 may be configured to acquire a neural network and optimize the neural network by adding and removing channels to the neural network using any of the methods described above. Similarly, the processor 1110 may train an optimized network or perform inferences with an optimized network to, for example, generate and display graphics, control a production process, or generally improve the computational efficiency of the apparatus for various tasks performed thereby, etc. The processor 1110 may be any combination of types of processors described herein and may also be referred to as processing hardware.

The memory 1120 is a non-transitory computer readable medium and stores computer-readable instructions, which when executed by the processor 1110, cause the processor 1110 to perform one or more, any combination, or all operations related to the optimization and/or training processes described above with respect to FIGS. 1-10.

The training/optimization apparatus 1100 may be connected to an external device, for example via a network or an input and output device to perform a data exchange. The training/optimization apparatus 1100 may be implemented as at least a portion of, or in whole as, for example, a mobile device such as a mobile phone, a smartphone, a PDA, a tablet computer, a laptop computer, and the like, a computing device such as a PC, a tablet PC, a netbook, and the like, and electronic products such as a TV, a smart TV, security equipment for gate control, and the like.

The one or more cameras 1130 may capture a still image, a video, or both, such as based upon control of the processor 1110. For example, one or more of the cameras 1130 may capture an image to be processed by an optimized neural network or to training an optimized neural network.

The storage device 1140 may be another memory and includes a computer-readable storage medium or a computer-readable storage device, for example. The storage device 1140 may also store a neural network. In one example, the storage device 1140 is configured to store a greater amount of information than the memory 1120, and configured to store the information for a longer period of time than the memory 1120, noting that alternative examples are also available. For example, the storage device 1140 may include, for example, a magnetic hard disk, an optical disc, a flash memory, a floppy disk, and nonvolatile memories in other forms that are well-known in the technical field to which the present disclosure pertains.

The one or more input devices 1150 are respectively configured to receive or detect input from the user, for example, through a tactile, video, audio, or touch input. The one or more input devices 1150 may include a keyboard, a mouse, a touch screen, a microphone, and other devices configured to detect an input from a user, or detect an environmental or other aspect of the user, and transfer the detected input to the processor 1110, memory 1120, and/or storage device 1140.

The one or more output devices 1140 may be respectively configured to provide the user with an output of the processor 1120, such as a result of an inference with an optimized neural network through a visual, auditory, or tactile channel configured by the one or more output devices 1140. The one or more output devices 1140 may further be configured to output results or information of other processes of the training/optimization apparatus 1100 in addition to the optimization/training/inference operations. In an example, the one or more output devices 1140 may include a display, a touch screen, a speaker, a vibration generator, and other devices configured to provide an output to the user, for example. The network interface 1170 is a hardware module configured to perform communication with one or more external devices through one or more different wired and/or wireless networks. The processor 1110 may control operation of the network interface 1170, for example, such as to acquire registration information from a server or to provide results of such registration or verification to such a server.

While embodiments and examples described above relate to techniques for optimizing neural networks, it will be appreciated that such optimization techniques for neural networks large enough to have practical value cannot be performed manually or mentally. For example, computing Equations 1 and 2 is only practical and useful when performed by a computing device. It will also be appreciated that when a computing device is configured to optimize a neural network, or use an optimized neural network to perform an inference, the overall efficiency of the computing device may be improved, e.g., the computing device may more efficiently/accurately control an industrial process, render graphics, allocate resources, detect objects (or make other inferences) in data stored in the computing device's memory. It will also be appreciated that, although some description herein uses mathematical terminology, such mathematical description is for convenience and efficient description; an ordinary engineer will be able to translate such mathematical description into actual code that may be compiled into machine-executable instructions that may configure the computing devices and apparatuses described herein to implement any of the methods described herein. Moreover, the practical applications of neural networks implemented in computing devices are myriad and well-known and therefore description thereof is omitted.

The computing apparatuses, the vehicles, the electronic devices, the processors, the memories, the image sensors, displays, the information output system and hardware, the storage devices, and other apparatuses, devices, units, modules, and components described herein with respect to FIGS. 1-11B are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11B that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method performed by a computing device comprising storage hardware storing a target network block and processing hardware that performs optimizing for the target network block, the method comprising:
generating, by the processing hardware, an extended network block of the target network block by increasing, in the storage hardware, a number of channels of a target operation branch in the target network block to a determined number of channels, wherein the target network block comprises operation branches that include the target operation branch, and wherein each operation branch comprises at least one respective channel;
determining, by the processing hardware, importance measures of the respective operation branches, including the target operation branch with the increased number of channels, in the extended network block; and
clipping, by the processing hardware, a channel of the target operation branch in the extended network block, wherein the clipping is performed according to the importance measures of the respective operation branches including the target operation branch.

2. The method of claim 1, further comprising generating an output of the target network block by splicing outputs of all the channels of the operation branches included in the target network block.

3. The method of claim 1, wherein the determined number of channels is determined to be equal to a total number of channels in the target network block.

4. The method of claim 1, wherein the generating of the extended network block comprises increasing the number of channels of each of the respective operation branches in the target network block to the determined number of channels.

5. The method of claim 1, wherein the channel is clipped such that a total number of channels remaining in the clipped extended network block is less than or equal to a total number of channels in the target network block.

6. The method of claim 1, wherein
the importance measure of each respective operation branch in the extended network block is based on an importance value of each respective channel thereof, and wherein
the clipping of the channel of the operation branch comprises selecting the target channel for clipping based on the target channel having an importance value that is not greater than an importance threshold.

7. The method of claim 6, wherein the clipping of the channel is performed such that, when a total number of remaining channels in the clipped extended network block is less than a total number of channels in the target network block, the importance threshold satisfies a requirement of a ratio of a number of channels of each operation branch in the clipped extended network block to a number of channels of a corresponding operation branch in the target network block to be equal to or greater than 0.2 and less than or equal to 1, and the ratio corresponding to each operation branch satisfies a requirement that all the ratios are not 1.

8. The method of claim 1,
wherein the determining of the importance value of each operation branch in the extended network block comprises:
determining a weight of each operation branch and a weight of each channel of each operation branch in the extended network block through a first equation, and
determining an importance of each operation branch in the extended network block, based on the weight of each operation branch and the weight of each channel of each operation branch, and
wherein the extended network block comprises m+1 operation branches and n+1 outputs, wherein the first equation comprises Fⱼ=Σᵢ₌₀^{m}Yᵢ×Wᵢⱼ×Fᵢⱼ, wherein Fⱼ is an output of sequence number j (j=0, 1, 2, . . . , n), Yᵢ is a weight of an operation branch of sequence number i (i=0, 1, 2, . . . , m), Wᵢⱼ is a weight of a channel of sequence number ij, Fᵢⱼ is an output of a channel of sequence number ij, and the channel of sequence number ij is a channel of sequence number j in the operation branch of sequence number i.

9. The method of claim 8, wherein the determining of the importance value of each operation branch in the extended network block, based on the weight of each operation branch and the weight of each channel of each operation branch comprises:
when Yᵢ×Wᵢⱼ, which is a weight product of a channel of sequence number ij, satisfies a second equation comprising Yᵢ×Wᵢⱼ=max{Y₀×W₀ⱼ, Y₁×W₁ⱼ, . . . , Yₘ×Wₘⱼ},
storing or marking, in the storage hardware, the channel of sequence number ij as a maximum-contribution channel, counting the number of maximum-contribution channels in each operation branch as a contribution number, and determining an importance of each operation branch according to the contribution number of each operation branch.

10. The method of claim 8, wherein the determining of the importance value of each operation branch in the extended network block comprises determining an importance measure of each respective operation branch based on a relationship between a weight product of each channel of each operation branch and a weight product threshold.

11. The method of claim 1, further comprising selecting the target network block from a neural network stored in the storage hardware, wherein the target network block comprises a sub-network of the neural network.

12. The method of claim 1, wherein the generating of the target network block comprises:
selecting a network block from a neural network of which the network block is a sub-network thereof, and
generating the target network block by adding an operation branch to the selected network block.

13. The method of claim 1, wherein the target network block comprises one network block that is a sub-network of a neural network, and wherein the method further comprises:
determining an importance measure of each respective operation branch in the network block, generating a transition network block by clipping at least one operation branch in the network block according to the importance measure of each operation branch, and generating the target network block by increasing a number of channels of at least one operation branch in the transition network block, wherein
a total number of channels of the target network block is less than a total number of channels in the network block.

14. An apparatus comprising:
processing hardware; and
storage hardware storing a target network block and storing instructions configured to, when executed by the processing hardware, configure the processing hardware to:
generate an extended network block by increasing a number of channels in a target operation branch in the target network block to a preset number of channels, wherein the target network block comprises operation branches that include the target operation branch, and wherein each operation branch comprises at least one respective channel;
determine an importance measure of each respective operation branch in the extended network block; and
clip a channel of the target operation branch in the extended network block according to the importance measures of the respective operation branches including the target operation branch.

15. The apparatus of claim 14, wherein the channel is clipped such that a total number of remaining channels in the clipped extended network block is less than or equal to a number of channels in the target network block.

16. The apparatus of claim 14, wherein
the importance measure of each operation branch in the extended network block is based on an importance measure of each respective channel thereof, and wherein
a channel is selected for clipping based having an importance value that is less than an importance threshold.

17. The apparatus of claim 16, wherein the clipping is performed such that
when a total number of remaining channels in the clipped extended network block is less than a total number of channels in the target network block,
the importance threshold satisfies a requirement of a ratio of a number of channels of each operation branch in the clipped extended network block to a number of channels of a corresponding operation branch in the target network block to be equal to or greater than 0.2 and equal to or less than 1, and
the ratio corresponding to each respective operation branch satisfies a requirement that all the ratios are not 1.

18. The apparatus of claim 14 wherein
a weight of each operation branch and a weight of each channel of each operation branch in the extended network block is determined through a first equation, and wherein an importance of each operation branch in the extended network block is determined based on the weight of each operation branch and the weight of each channel of each operation branch,
wherein the extended network block comprises m+1 operation branches and n+1 outputs, wherein the first equation comprises Fⱼ=Σᵢ₌₀^{m}Yᵢ×Wᵢⱼ×Fᵢⱼ, and
wherein Fⱼ denotes an output of sequence number j (j=0, 1, 2, . . . , n), Yᵢ is a weight of an operation branch of sequence number i(i=0, 1, 2, . . . , m), Wᵢⱼ is a weight of a channel of sequence number ij, Fᵢⱼ is an output of a channel of sequence number ij, and the channel of sequence number ij is a channel of sequence number j in the operation branch of sequence number i.

19. The apparatus of claim 18, wherein,
the importance value of each respective operation branch in the extended network block is determined based on the weight of each respective operation branch and the weight of each respective channel of each respective operation branch, wherein
when Yᵢ×Wᵢⱼ, which is a weight product of a channel of sequence number ij, satisfies a second equation comprising Yᵢ×Wᵢⱼ=max{Y₀×W₀ⱼ, Y₁×W₁ⱼ, . . . , Yₘ×Wₘⱼ}, wherein
the channel of sequence number ij is marked or stored in the storage hardware as a maximum-contribution channel, and wherein
a count of the number of maximum-contribution channels in each operation branch is stored as a contribution number, and wherein
an importance of each operation branch is determined according to the respectively corresponding contribution number.

20. The apparatus of claim 18, wherein,
when the importance value of each respective operation branch in the extended network block is determined based on the weight of each operation branch and the weight of each channel of each operation branch,
an importance value of each operation branch is determined according to a relationship between a weight product of each channel of each operation branch and a weight product threshold.

21. A method performed by a computing device comprising processing hardware and storage hardware, the method comprising:
optimizing, by the processing hardware, a neural network stored in the storage hardware, the optimizing comprising:
selecting a network block from the neural network, the network block comprising branches, each branch comprising a respective original number of original channels, wherein each original channel comprises a respective channel weight, and wherein the branches include a target branch;
determining a number of extension channels to add to the network block based at least on the number of channels of a target branch, and adding the determined number of extension channels to the network block such that the network block comprises the original channels and the extension channels; and
pruning a target channel from the network block, the target channel comprising one of the extension channels or one of the original channels.

22. The method of claim 21, wherein at least one branch in the finalized network block comprises a plurality of the original channels and a plurality of the extension channels, and wherein a total number of channels in the finalized network block comprises a total number of the original channels before the adding of the extension channels.

23. The method of claim 21, further comprising:
generating importance measures for the respective branches; and
selecting a branch for pruning, or for pruning a channel thereof, based on the importance measures.

24. The method of claim 23, wherein the importance measure of a corresponding branch is generated based on the channel weights thereof.

25. The method of claim 24, wherein the target channel is selected from among the extension and original channels of the target branch based on the selection of the target branch.
